(19) United States
(12) Patent Application Publication
(10) Pub. No.: US 2016/0342252 A1
(43) Pub. Date: Nov. 24, 2016

(54) COMPUTER DEVICE WITH A TOUCH CONTROLLER AND METHOD FOR UPDATING THE TOUCH CONTROLLER

(71) Applicant: ELAN MICROELECTRONICS CORPORATION, Hsinchu (TW)

(72) Inventor: I-Hau YEH, Taipei City (TW)

(21) Appl. No.: 15/068,015

(22) Filed: Mar. 11, 2016

Related U.S. Application Data
(60) Provisional application No. 62/163,390, filed on May 19, 2015.

(30) Foreign Application Priority Data
Oct. 2, 2015 (TW) 104132555

(51) Int. Cl. G06F 3/041; G06F 13/40; G06F 9/445

(52) U.S. Cl. CPC G06F 3/0412; G06F 9/445; G06F 13/4027

(57) ABSTRACT

A computer device with a touch controller and a method for updating the touch controller are provided in the present invention. The updating method comprise writing a first touch parameter and a first touch procedure which are saved in a memory of a BIOS or saved in a storage device with a driver program into an RAM of the touch controller when the computer device is power on so as to allow the touch controller to execute operation by utilizing the first touch parameter and the first touch procedure. Since the touch controller needs no flash memory to update a touch firmware, the cost of the touch controller is lower.

### CROSS-REFERENCE TO RELATED APPLICATIONS

This application claims the priority benefits of U.S. Provisional Application No. 62/163,390, filed 19 May 2015, entitled “Driving Method for Touch Screen”, and Taiwan Patent Application No. 104132555, filed 2 Oct. 2015, both of which are hereby incorporated herein by reference in their entirety.

### FIELD OF THE INVENTION

The present invention is related generally to a touch controller and, more particularly, to a method for updating the touch controller.

### BACKGROUND OF THE INVENTION

Conventionally, a touch controller of a touch device requires a flash memory to save a touch firmware. When the environmental characteristics of the touch device are changed, the firmware of the touch controller of the touch device can be update.

The touch device, such as a touch pad, is widely applied in the notebooks. The firmware in the touch controller of the touch device needs to be updated in some circumstances. There are two common methods for updating the touch firmware; one of the methods is In-Application Programming (IAP), and the other of the methods is In-System Programming (ISP). Both methods for updating the touch firmware require a flash memory to accomplish. Namely, the present touch controller needs to use a flash memory process of a high cost. Moreover, it requires a programming process to write the flash memory, and the programming process is complicated and slow. Further, due to different environmental characteristics, for example, different laptop computers have different top covers which are configured to cover the touch device or have different iron modules which are configured to fix the touch device, it needs to prepare many the touch controllers which have dissimilar touch firmwares. Accordingly, materials management is difficult.

FIG. 1 shows a method for updating a firmware of an embedded controller 26 disclosed in a U.S. Patent Publication No. 2007/0260790. The embedded controller (EC) 26 is connected to a basic input output system (BIOS) 28. The EC 26 includes a flash memory and manages several peripheral devices, such as the touch pad and the keyboard. Before the computer or a south bridge controller 30 is power on, the EC 26 is switched to a host mode to download the firmware from the BIOS 28 and to write the firmware into the flash memory. After the firmware is updated, the EC 26 will be switched to a device mode. However, such method for updating the firmware still requires the flash memory and the programming process to write the firmware into the flash memory. Accordingly, such updating method still has the same problems that are the high cost and the slow update. Moreover, both the EC 26 and the BIOS 28 belong to elements of a motherboard. Namely, aforementioned disclosure merely provides a method for updating the EC 26 on the motherboard. The method for updating the peripheral devices, such as the touch pad or the keyboard, managed by the EC 26 has not been mentioned.

### SUMMARY OF THE INVENTION

An objective of the present invention is to provide a computer device with a touch controller of a low cost and a method for updating the touch controller.

According to the present invention, a computer device comprises a touch device and a BIOS. The touch device has a touch controller which includes a random access memory (RAM). The BIOS includes a memory for saving a first touch parameter and a first touch procedure. The first touch procedure is for providing a first touch function. The first touch parameter and the first touch procedure are parts of a touch firmware. When the computer is power on, the BIOS will send the first touch parameter and the first touch procedure to the touch controller. After the touch controller saves the first touch parameter and the first touch procedure in the RAM, the touch controller executes operation by utilizing the first touch parameter and the first touch procedure.

According to the present invention, a method for updating a touch controller comprises steps of: sending a first touch parameter and a first touch procedure that are saved in a memory of a BIOS of a computer device to the touch controller when the computer device is power on, wherein the first touch parameter and the first touch procedure are parts of a touch firmware and the first touch procedure is for providing a first touch function; and saving the first touch parameter and the first touch procedure in an RAM of the touch controller so as to allow the touch controller to execute operation by utilizing the first touch parameter and the first touch procedure.

According to the present invention, a computer device comprises a touch device and a storage device. The touch device has a touch controller which includes an RAM. The storage device is coupled to the touch device and saves a driver program, a first touch parameter and a first touch procedure. The first touch procedure is for providing a first touch function. The first touch parameter and the first touch procedure are parts of a touch firmware. When the computer device executes the driver program, the first touch parameter and the first touch procedure will be sent to the touch controller. After the touch controller saves the first touch parameter and the first touch procedure into the RAM, the touch controller executes operation by utilizing the first touch parameter and the first touch procedure.

According to the present invention, a method for updating a touch controller comprises steps of: executing a driver program to send a first touch parameter and a touch procedure to the touch controller, wherein the first touch parameter and the first touch procedure are parts of the touch firmware and the first touch procedure is for providing a first touch function; and saving the first touch parameter and the first touch procedure into an RAM of the touch controller so as to allow the touch controller to execute operating by utilizing the first touch parameter and the first touch procedure.

The present invention saves the firmware or the parameters of the touch controller in a memory of a BIOS or in a storage device that includes the driver program. After the computer device is power on, the firmware or the parameters are written into the RAM of the touch controller. Accordingly, the touch controller acquires a new firmware or parameters. The method of the present invention allows the touch controller to get rid of the flash memory. The touch controller of the present invention can use a logic process of low costs. Further, the new firmware or parameters are written into the RAM, which means that the programming process is not required and the update can be speeded up.

According to the present invention, a touch controller may only have a basic touch function. A first touch parameter and a first touch procedure, which are designed in accordance with characteristics of different computer device or other specific need, are in a memory of a BIOS or in a storage device that saves a driver program. After the computer device is power on, the first touch parameter and the first touch procedure are written into a RAM of the touch controller. Thus, the same touch controller can be applied to various computer devices with different environmental characteristics so as to make the materials management easier.

### BRIEF DESCRIPTION OF THE DRAWINGS

These and other objectives, features and advantages of the present invention will become apparent to those skilled in the art upon consideration of the following description of the embodiments according to the present invention taken in conjunction with the accompanying drawings, in which:

FIG. 1 is a block diagram showing a conventional method for updating a firmware;

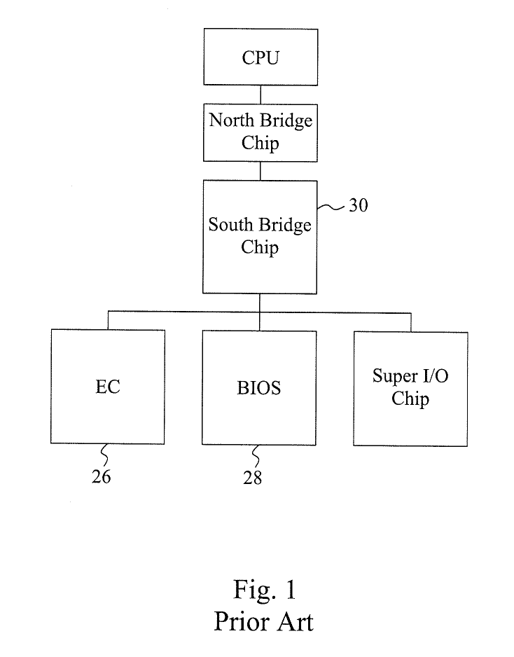

FIG. 2 is a block diagram showing a first embodiment of the present invention;

FIG. 3 is a block diagram showing a second embodiment of the present invention; and

FIG. 4 is a block diagram showing a third embodiment of the present invention.

### DETAILED DESCRIPTION OF THE INVENTION

The touch firmware generally includes an algorithm, a touch parameter, and a touch procedure. The algorithm is a basic function program of a touch device. The basic function program is, for example, for detecting and computing the amount and the location of objects that touch a touch device. Wherein, even if the environmental characteristics are changed, the algorithm will not be changed. The touch parameter is generated in accordance with the material and the thickness of the touch device, components (top cover and iron module) of a computer device, or the practical occasions. The touch parameter may include a touch sensitivity parameter, a cursor speed parameter, or a noise filter parameter. The touch procedure is for providing an operational function, such as a palm rejection function and a multi-touch function.

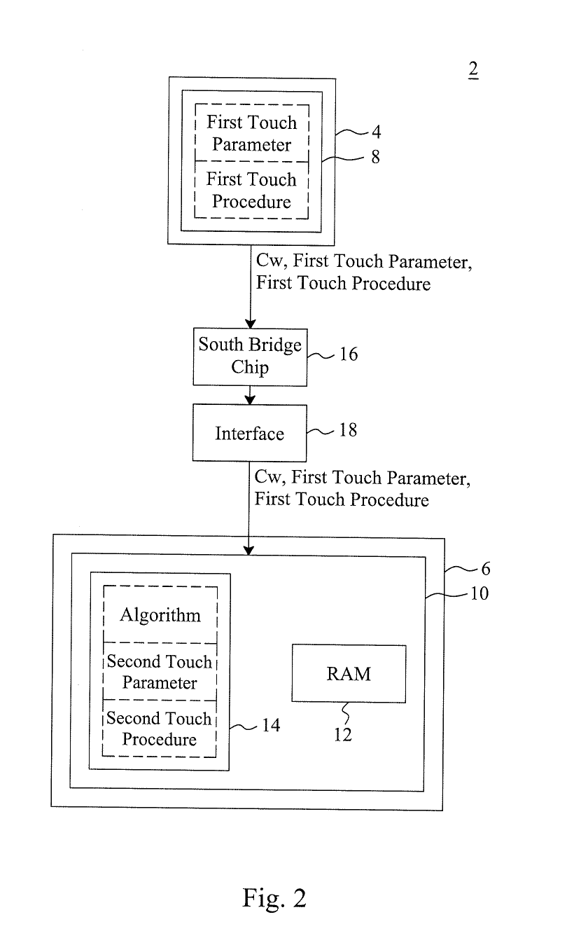

FIG. 2 shows a first embodiment of the present invention. A computer device 2 includes a BIOS 4, a touch device 6, a south bridge controller 16 connected to the BIOS 4 and an interface 18 connected to the touch device 6. In this embodiment, the south bridge controller 16 is directly connected to the interface 18. Alternatively, the south bridge controller 16 can be connected to the interface 18 via other component. A memory 8 in the BIOS 4 saves a first touch parameter and a first touch procedure. A touch controller 10 in the touch device 6 includes a random access memory (RAM) 12, and a read only memory (ROM) 14. The ROM 14 saves an algorithm, a preset second touch parameter and a preset second touch procedure. Wherein, the first touch parameter could be, for example, a touch sensitivity parameter, a cursor speed parameter, a noise filter parameter, or other parameters that are corresponding to related environmental characteristics. The first touch procedure is for providing a first touch function, such as a palm rejection function and a multi-touch gesture function. The second touch parameter includes a general standard parameter. The second touch procedure is for providing a second operation function, such as a cursor operation function. Before the first touch parameter and the first touch procedure are loaded to the touch controller 10, the touch device 6 executes basic operations, such as a cursor control, according to the second touch parameter and the second touch procedure in the ROM 14. When the computer device 2 is power on, the touch firmware update will be performed after the BIOS 4 is on. Wherein, the BIOS 4 sends a write command Cw, the first touch parameter and the first touch procedure to the touch controller 10 of the touch device 6 via the south bridge controller 16 and the interface 18. After the touch controller 10 receives the write command Cw, the touch controller 10 will save the first touch parameter and the first touch procedure into the RAM 12. Then, the touch controller 10 can utilize the first touch parameter and the first touch procedure in the RAM 12 to execute operation.

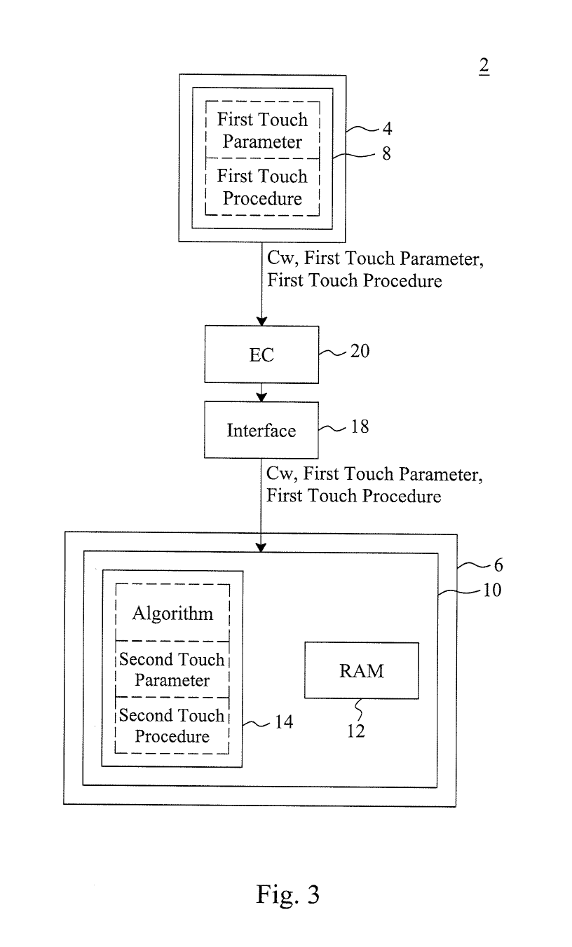

The BIOS 4 can send the first touch parameter and the first touch procedure to the touch controller 10 via different paths. FIG. 3 shows a second embodiment of the present invention. The computer device 2 includes the BIOS 4, the touch device 6, an embedded controller (EC) 20 connected to the BIOS 4, and the interface 18 connected to the touch device 6. In this embodiment, the embedded controller 20 is directly connected to the interface 18. Alternatively, the embedded controller 20 can be connected to the interface 18 via other component. Similarly, the memory 8 in the BIOS 4 in FIG. 3 saves the first touch parameter and the first touch procedure for updating. The ROM 14 of the touch controller 10 saves an algorithm, a preset second touch parameter and a preset second touch procedure. Before the first touch parameter and the first touch procedure are loaded into the touch controller 10, the touch device 6 executes basic operations according to the second touch parameter and the second touch procedure in the ROM 14. When the computer device 2 is power on, the BIOS will perform touch firmware update after the BIOS 4 is start-up. At this time, the BIOS 4 sends a write command Cw, the first touch parameter and the first touch procedure to the touch controller 10 of the touch device 6 via the embedded controller 20 and the interface 18. After the touch controller 10 receives the write command Cw, the touch controller will write the first touch parameter and the first touch procedure into the RAM 12.

In the embodiments shown in FIGS. 2 and 3, the duration from the computer device 2 being power on to the BIOS 4 being start-up is very short. The touch firmware will be updated before using the touch device 6. Accordingly, in other embodiments, the ROM 14 does not have to save the second touch parameter and the second touch procedure.

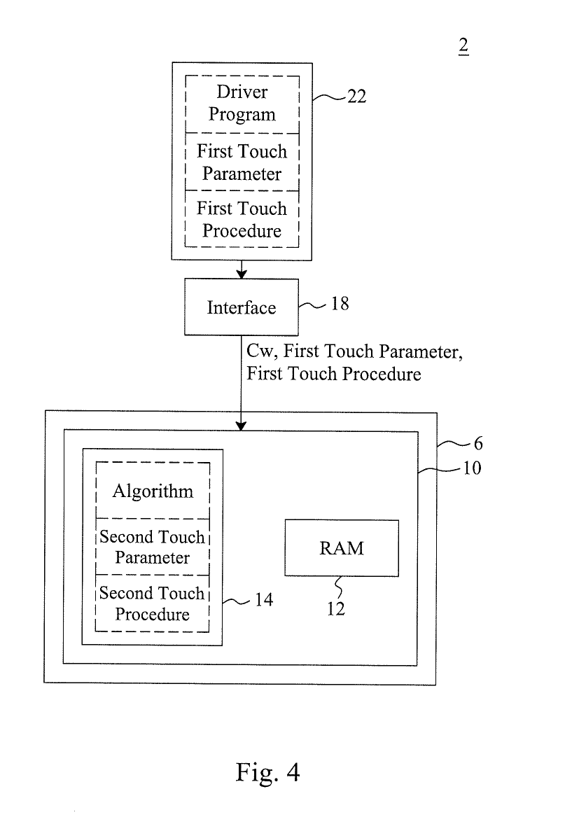

FIG. 4 shows a third embodiment of the present invention. The computer device 2 includes a storage device 22, the touch device 6 and the interface 18 connected to the touch device 6. In this embodiment, the storage device 22 is directly connected to the interface 18. Alternatively, the storage device 22 can be connected to the interface 18 via other component. The storage device 22 saves several driver programs that are utilized by the computer device 2 and also saves the first touch parameter and the first touch procedure. The driver programs include a driver program that is utilized to execute the updating of the touch firmware. The touch controller 10 of the touch device 6 includes the RAM 12 and the ROM 14. The ROM 14 saves the algorithm, the preset second parameter, and the preset second touch procedure. Before the first touch parameter and the first touch procedure are loaded into the touch controller 10, the touch device 6 executes basic operations according to the second touch parameter and the second touch procedure in the ROM 14. When the computer device 2 is power on, the driver program for updating the touch firmware will be executed to make the storage device 22 to send a write command Cw, the first touch parameter and the first touch procedure to the touch controller 10 of the touch device 6 via the interface 18. The touch controller 10 saves the first touch parameter and the first touch procedure into the RAM 12 according to the write command Cw. Then, the touch controller 10 executes operation by utilizing the first touch parameter and the first touch procedure in the RAM 12.

In other embodiments, a new algorithm can be also saved in the memory 8 in the BIOS 4 or the storage device 22. According to the methods as described by the foregoing embodiments, the new algorithm can be write into the RAM 12 of the touch controller 10, so that the touch controller 10 can use the new algorithm.

In FIGS. 2, 3, and 4, the touch controller 10 that is using the updating method of the present invention only requires the RAM 12 and the ROM 14. Since the touch controller 10 doesn't need a flash memory, the touch controller 10 can be manufactured by a logic process of low costs. Thus, the costs of the touch controller 10 can be decreased. In comparison with the capacity of the memory 8 of the BIOS 4 or the storage device 22, the first touch parameter and the first touch procedure are very small. Thus, the memory 8 or the storage device 22 does not need to increase extra capacity so that the costs will not increase. Moreover, the present invention does not need the programming process described in the background to write the first touch parameter and the first touch procedure in the RAM 12. Namely, the method for updating the firmware of the touch controller of the present invention provides a faster updating. Additionally, there is only the firmware that is needed when the touch controller executes the basic operation is previously saved in the ROM 14 of the touch controller 10. The first touch parameter and the first touch procedure that are conforming to different needs can be provided to the touch controller 10 via aforementioned manners. Thus, the same touch controller 10 can be suited to various computer devices, which contributes to an easier material management.

In one embodiment, after the first touch parameter and the first touch procedure are loaded, the touch controller 10 executes operation simply according to the first touch parameter and the first touch procedure. The preset second touch parameter and the preset second touch procedure saved in the ROM 14 of the touch controller 10 will not be used. In other embodiments, after the first touch parameter and the first touch procedure are loaded, the touch controller 10 still utilizes a part or all of the second touch parameter and the second touch procedure. Namely, according to the present invention, the first touch parameter and the first touch procedure can replace the second touch parameter and the second touch procedure previously saved in the ROM 14 of the touch controller 10, or can provide more functions besides the basic operations.

While the present invention has been described in conjunction with embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A computer device, comprising:
a touch device having a touch controller which include a random access memory (RAM); and
a basic input output system (BIOS) coupled to the touch device and including a memory for saving a first touch parameter and a first touch procedure which is for providing a first touch function;
wherein, when the computer device is power on, the BIOS will send the first touch parameter and the first touch procedure to the touch controller, and after the touch controller saves the first touch parameter and the first touch procedure into the RAM the touch controller will execute operation by utilizing the first touch parameter and the first touch procedure.

2. The computer device of claim 1, further comprising:
a south bridge controller coupled to the BIOS; and
an interface connected between the south bridge controller and the touch controller;
wherein, the first touch parameter and the first touch procedure sent from the BIOS are delivered to the touch controller via the south bridge controller and the interface.

3. The computer device of claim 1, further comprising:
an embedded controller coupled to the BIOS; and
an interface connected between the embedded controller and the touch controller;
wherein, the first touch parameter and the first touch procedure sent from the BIOS are delivered to the touch controller via the embedded controller and the interface.

4. The computer device of claim 1, wherein the first touch parameter includes a touch sensitivity parameter, a cursor speed parameter, or a noise filter parameter.

5. The computer device of claim 1, wherein the first touch function includes a palm rejection function or a multi-touch gesture function.

6. The computer device of claim 1, wherein the touch controller further includes a read only memory (ROM) for saving a preset second touch parameter and a preset second touch procedure, and the second touch procedure is for providing a second touch function.

7. The computer device of claim 6, wherein the second touch function includes a cursor operation function.

8. The computer device of claim 1, wherein the memory saves an algorithm which is sent to the touch controller by the BIOS when the computer device is power on, and after the touch controller saves the algorithm into the RAM, the touch controller executes operation by utilizing the algorithm.

9. A method for updating a touch controller, comprising steps of:
sending a first touch parameter and a first touch procedure that are saved in a memory of a basic input output system (BIOS) of a computer device to the touch controller when the computer device is power on, wherein the first touch procedure is for providing a first touch function; and
saving the first touch parameter and the first touch procedure into a random access memory (RAM) of the touch controller so as to allow the touch controller to execute operation by utilizing the first touch parameter and the first touch procedure.

10. The method of claim 9, wherein the first touch parameter includes a touch sensitivity parameter, a cursor speed parameter, or a noise filter parameter.

11. The method of claim 9, wherein the first touch function includes a palm rejection function or a multi-touch gesture function.

12. The method of claim 9, wherein before the first touch parameter and the first touch procedure are saved into the RAM, the touch controller executes operation by utilizing a preset second touch parameter and a preset second touch procedure that are saved in a read only memory (ROM) thereof.

13. The method of claim 12, wherein the second touch procedure is for providing a second touch function which includes a cursor operation function.

14. The method of claim 9, further comprising steps of:
sending an algorithm saved in the memory of the BIOS to the touch controller when the computer device is power on; and
saving the algorithm in the RAM of the touch controller so as to allow the touch controller to execute operation by utilizing the algorithm.

15. A computer device, comprising:
a touch device having a touch controller which is including a random access memory (RAM); and
a storage device coupled to the touch device for saving a driver program, a first touch parameter, and a first touch procedure which is for providing a first touch function;
wherein, when the driver program is executed, the first touch parameter and the first touch procedure will be sent to the touch controller, and after the touch controller saves the first touch parameter and the first touch procedure into the RAM, the touch controller will execute operation by utilizing the first touch parameter and the first touch procedure.

16. The computer device of claim 15, further comprising an interface connected between the storage device and the touch controller for transmitting the first touch parameter and the first touch procedure to the touch controller.

17. The computer device of claim 15, wherein the first touch parameter includes a touch sensitivity parameter, a cursor speed parameter, or a noise filter parameter.

18. The computer device of claim 15, wherein the first touch function includes a palm rejection function or a multi-touch gesture function.

19. The computer device of claim 15, wherein the touch controller further includes a read only memory (ROM) that saves a preset second touch parameter and a preset second touch procedure which is for providing a second touch function.

20. The computer device of claim 19, wherein the second touch function includes a cursor operation function.

21. The computer device of claim 15, wherein the storage device saves an algorithm that is sent to the touch controller when the driver program is executed, and after the touch controller saves the algorithm into the RAM, the touch controller will execute operation by utilizing the algorithm.

22. A method for updating a touch controller, comprising steps of:
executing a driver program to send a first touch parameter and a first touch procedure to the touch controller, wherein the first touch procedure is for providing a first touch function; and
saving the first touch parameter and the first touch procedure into a random access memory (RAM) of the touch controller so as to allow the touch controller to execute operation by utilizing the first touch parameter and the first touch procedure.

23. The method of claim 22, wherein the first touch parameter includes a touch sensitivity parameter, a cursor speed parameter, or a noise filter parameter.

24. The method of claim 22, wherein the first touch function includes a palm rejection function or a multi-touch gesture function.

25. The method of claim 22, wherein before the first touch parameter and the first touch procedure are saved into the RAM, the touch controller executes operation by utilizing a preset second touch parameter and a preset second touch procedure that are saved in a read only memory (ROM) thereof.

26. The method of claim 25, wherein the second touch procedure provides a second touch function that includes a cursor operation function.

27. The method of claim 22, further comprising steps of:
executing the driver program to send an algorithm to the touch controller; and
saving the algorithm into the RAM of the touch controller so as to allow the touch controller to execute operation by utilizing the algorithm.
